(19) United States
(12) Patent Application Publication
(10) Pub. No.: US 2004/0057654 A1
(43) Pub. Date: Mar. 25, 2004

(54) Devices and methods for switching transmission of light from one fiber to another

(76) Inventors: David Baasch, Portland, OR (US); Charles Osborne, Portland, OR (US)

Correspondence Address: Marger Johnson & McCollom, 1030 S W Morrison Street, Portland, OR, 97205, US

(21) Appl. No.: 10/466,234

(22) PCT Filed: Jan. 4, 2002
(86) PCT No.: PCT/US02/00231

(51) Int. Cl. G02B 6/35

(52) U.S. Cl. 385/16; 385/22

(57) ABSTRACT

Disclosed are devices and methods for switching transmission of light from one optical fiber to another. A steerable fiber has an end in a capsule, as do one or more cooperating fibers. Initially the steerable fiber is at a rest position, from where it couples light into one of the cooperating fibers. The end of the steerable fiber includes an armature that moves in response to applied magnetic fields. Then a magnetic field is generated selectively, and a pair of pole pieces transfers it to a location inside the capsule, which is close to the armature. Thus the end of the steerable fiber is moved to another position, from where it couples light into the other cooperating fiber.

### CROSS-REFERENCE TO RELATED APPLICATIONS

This application claims priority from U.S.A. Provisional Application No. 60/261,351 filed on Jan. 12, 2001, and international application number PCT/US02/00231, filed Jan. 4, 2002, which are hereby incorporated by reference.

### BACKGROUND OF THE INVENTION

1. Field of the Invention

The present invention is related to the field of fiber optics communications, and more specifically to devices and methods for switching transmission of light from one optical fiber to another.

2. Description of the Related Art

Light signals are transmitted through optical fibers. These are very thin, and made in very large lengths (e.g. of the order of 1 km or longer).

Often electrical signals are converted to light signals, then transmitted through fibers, and then reconverted to electrical signals. Fibers are thus widely use for wired communications over long distances, such as for telephone lines, etc.

It is often desirable to have an optical fiber switch device. That device can receive light from one fiber (often called the feeding fiber), and couple it to a receiving fiber. Or it can couple the received light selectively to one of many receiving fibers. This prevents the need of reconverting a light signal to an electrical signal for switching between channels, and then converting it back to a light signal for continuing transmission.

Optical fiber switch devices are implemented in a number of ways in the prior art. A first such way is described herein as FIG. 1 and FIG. 2. It has been reproduced from an article titled: Mechanical Optical-Fibre Switch, Electronics Letters Vol. 12, Jul. 22 1976.

Referring to FIG. 1, prior art switch 100 is provided in a glass tube 110 that defines an enclosure 115. A feeding fiber 120 enters enclosure 115, and couples light into either one of receiving fiber 132 or receiving fiber 134. Enclosure 115 may be sealed, and filled with propyl alcohol to keep the ends of fibers 120, 132, 134 clean.

Referring to FIG. 2, a cross section of tube 110 is shown, at a plane where receiving fibers 132, 134 have their inputs. Tube 110 internally has a square cross section, and receiving fibers 132, 134 are at corners of the square, in corresponding grooves. Feeding fiber 120 can be more reliably aligned with either one of receiving fibers 132, 134, by being driven to the same groove.

Returning to FIG. 1, feeding fiber 120 has a ferromagnetic sleeve 140, made from nickel. This way the output end of fiber 110 can be driven to either groove by applying magnetic forces. These may be established by electromagnets (not shown).

Other implementations (not shown separately) use a reed switch to switch the device on and off, by deflecting or not the output end of the feeding fiber from an aligned position. A conventional reed runs along the entire length of the portion of the feeding fiber that is within tube 110 of the prior art. The magnetic field runs parallel to the conventional reeds, and in fact, it magnetizes them.

A consistent problem in the prior art is that large magnetic fields are needed to accomplish switching in devices such as that of FIG. 1. That is because the electromagnets for establishing the field are best placed outside the portion encapsulated by the glass tube, and therefore at a large distance from the fiber that is to be steered by applying the magnetic field. Due to the large distance, these electromagnets require a lot of electrical current to activate, more than is justified for a mere switch.

The problem has not been addressed satisfactorily in the prior art.

First, in the prior art of FIG. 1 the problem does not seem addressed at all. In fact, the disclosure of the reference does not seem fully implemented. The reference even concludes with a statement that the authors intend to proceed with development along the lines indicated in the disclosure. The reference seems to treat the actual process of switching as an abstraction, without addressing the large size of the requisite magnetic fields. In fact, sleeve 140 seems shorter than subsequent, actual implementations.

Second, in the aforementioned implementations of reed switches, a large reed is used, which is at least as long as the whole output end of the output fiber. This was done for better magnetic coupling. Still, such switches require a lot of current.

Third, referring to FIG. 3, another device in the prior art actually solves this problem, but by increasing mechanical complexity and thus also cost. The solution of FIG. 3 of the present document is taught in U.S. Pat. No. 4,415,229.

In FIG. 3, a device 300 receives a feeding fiber 317 (near the top) goes through a guiding sphere 320. Sphere 320 can be rotated to various orientations, for aligning the free end of feeding fiber 317 with the receiving end of any one of receiving fibers 310. Sphere 320 is steered to these various orientations by electromagnets 326 attracting selectively a disc 319 fitted about sphere 320.

All this is done so that magnetic fields need not be applied over large distances. Indeed, sphere 320 is placed in a socket, and helps form an enclosure 330 that contains the free ends of feeding fiber 317 and receiving fibers 310. This way disc 319 is wholly outside enclosure 330, which permits it to be located closely to electromagnets 326.

The drawback here is a very complex structure with mechanical parts moving against each other. This makes it expensive, and of a shorter useful life.

It is desirable to have an inexpensive, durable fiber-to-fiber switch.

### BRIEF SUMMARY OF THE INVENTION

The present invention overcomes these problems and limitations of the prior art.

Generally, the present invention provides devices and methods for switching transmission of light from one fiber to another. A steerable fiber terminates in a capsule, as do one or more cooperating fibers. For switching, the steerable fiber is moved to exchange light selectively with one of the cooperating fibers.

The end of the steerable fiber includes an armature that moves in response to applied magnetic fields. At least one magnetic field is generated, and a pair of pole pieces transfers it to a location inside the capsule that is close to the armature.

The invention offers the advantage that the generated magnetic field need not be large, thus conserving electric current. Indeed, the pole pieces terminate in a short distance between them, to generate relatively large field strength. A switch is thus created that is economical to operate.

In addition, by further terminating close to the armature, the strength of the generated magnetic field need not be large in the first place. Furthermore, the armature itself need not be large, and maybe manufactured economically near the end of the steerable fiber as a sphere. A switch is thus simple, and further economical to manufacture.

The invention will become more readily apparent from the following Detailed Description, which proceeds with reference to the drawings, in which:

### BRIEF DESCRIPTION OF THE DRAWINGS

FIG. 1 is a diagram of a fiber-to-fiber switching device in the prior art.

FIG. 2 is a cross sectional diagram of a tube of the device of FIG. 1.

FIG. 3 is a diagram of another fiber-to-fiber switching device in the prior art.

FIG. 4A is a perspective view of a fiber-to-fiber switching device made according to an embodiment of the present invention.

FIG. 4B is a top view of salient parts of the device of FIG. 4A, showing one of its attainable switching states.

FIG. 4C is a top view of salient parts of the device of FIG. 4A, showing another one of its attainable switching states.

FIG. 5A is a perspective view of a fiber-to-fiber switching device made according to another embodiment of the present invention.

FIG. 5B is a top view of salient parts of the device of FIG. 5A, showing one of its attainable switching states.

FIG. 5C is a top view of salient parts of the device of FIG. 5A, showing another one of its attainable switching states.

FIG. 6A is a perspective view of a fiber-to-fiber switching device made according to yet another embodiment of the present invention.

FIG. 6B is a top view of salient parts of the device of FIG. 6A, showing it at a rest state.

FIG. 6C is a top view of salient parts of the device of FIG. 6A, showing it at a first one of its attainable switching states.

FIG. 6D is a top view of salient parts of the device of FIG. 6A, showing it at a second one of its attainable switching states.

FIG. 7 is a flowchart illustrating a method according to an embodiment of the present invention.

FIG. 8 is a plan view of parts of a switch, for describing technical implementation details of the invention.

FIG. 9 is a detailed view of a steerable optical fiber in the device of FIG. 8.

FIG. 10 is a schematic view of an arrangement of pole pieces operating to move a single steerable fiber along different directions for placing in horizontally disposed grooves.

FIG. 11 is a plan view of an arrangement where feeding fibers share a common armature according to an embodiment of the invention.

### DETAILED DESCRIPTION OF THE PREFERRED EMBODIMENT(S)

As has been mentioned, the present invention provides devices and methods for switching transmission of light from one fiber to another. A steerable fiber terminates in a capsule, as do one or more cooperating fibers. For switching, the steerable fiber is moved to exchange light selectively with one of the cooperating fibers. The invention is now described in more detail.

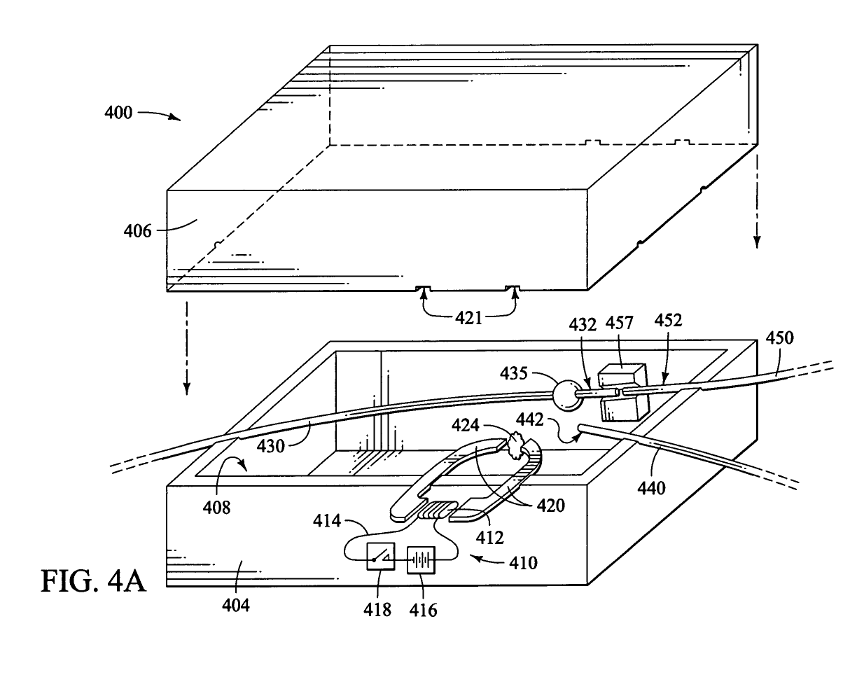

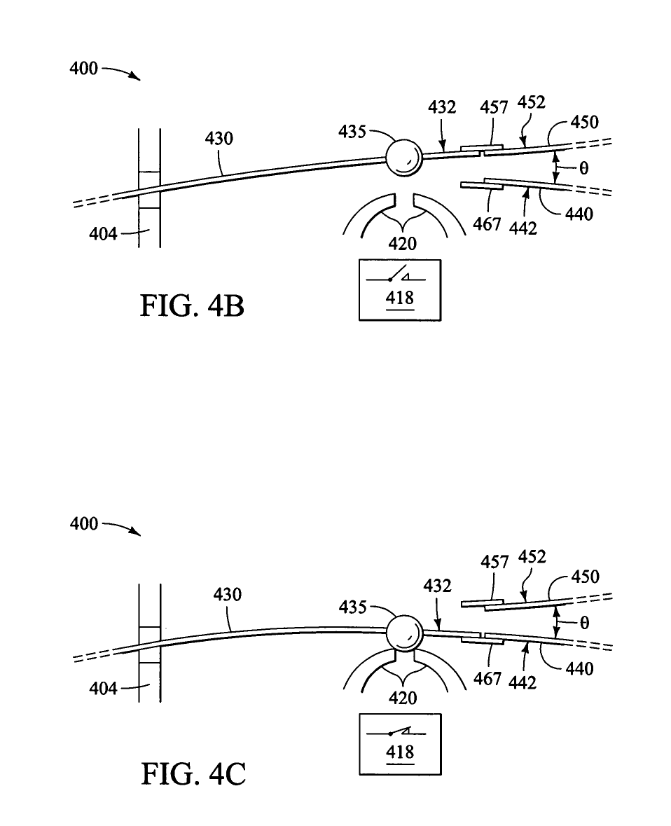

Referring now to FIG. 4A, a fiber-to-fiber switch 400 is shown. Switch 400 includes a capsule made from a bottom half 404 and a top half 406. In FIG. 4A, top half 406 is shown separated and raised from bottom half 404 to better illustrate other important components of switch 400.

Top half 406 normally closes down on bottom half 404, to make the switch rugged. When the two halves are closed, an interior 408 of the capsule may optionally be filled with an index matching fluid, to improve coupling of light between the fibers.

Switch 400 also includes a first electromagnet 410 for selectively generating a first magnetic field. First electromagnet 410 includes at least a coil 412 and a wire 414 wrapped around coil 412.

First electromagnet 410 is operated by electrical power source such as battery 416, and a switch 418 for controlling when electrical current flows around coil 412. Switch 418 may be electronic, and be switched ON and OFF by an electronic switching signal.

First electromagnet 410 is outside the capsule, although that is not necessary. First electromagnet 410 may equivalently be implemented within the capsule.

Switch 400 moreover includes a first pair of pole pieces 420. Pole pieces 420 transfer the first generated magnetic field from the tips of coil 412 to a first transferred field location 424 inside the capsule near the tips of pole pieces 420. Pole pieces 420 are preferably made from a material that conducts well a magnetic field.

At least the tips of pole pieces 420 are in part inside the capsule. If first electromagnet 410 is wholly within the capsule, then pole pieces 420 may also be wholly within the capsule.

In the preferred embodiment, coil 412 of first electromagnet 410 is outside the capsule. Pole pieces 420 then transfer the first generated magnetic field through a wall of the capsule.

Pole pieces 420 are preferably thin, so as to interfere only minimally with a lip of top half 406, as it closes with bottom half 404 to form the capsule. The two halves may be sealed together using a foamy material between them, which accommodates a small thickness of pole pieces 420. Alternately, one of the two halves (here top half 406) may have recesses 421 at the lip, for accommodating pole pieces 420.

Switch 400 additionally includes a steerable fiber 430, having an end 432 in the capsule. End 432 is also known as the output end of steerable fiber 430.

A large portion of steerable fiber 430 is outside the capsule, including a remote end of fiber 430. This large portion, along with the remote end are not shown, as unimportant to switch 400. End 432 in the capsule is steerable, as will be explained below.

Fiber 430 is generally mounted on the bottom half 404 of the capsule. Mounting may be to a pedestal, which may in turn be mounted on the bottom half 404. Alternately, mounting may be to a wall or lip of bottom half 404.

Switch 400 further includes an armature 435 attached to steerable fiber 430 near end 432. Armature 435 may be a standalone magnet, by being made from material which is inherently magnetized, or has been made to acquire magnetism. Alternately, armature 435 may be made from soft magnetic material, which responds to magnetic field, but does not retain magnetism.

It is highly preferred that the first transferred field location 424 is designed to be close to armature 435. This way armature 435 is responsive to the transferred first magnetic field by being magnetically biased with respect to the first transferred field location 424. If armature 435 has no magnetism, then being magnetically biased means being attracted towards the first transferred field location 424. On the other hand, if armature 435 has magnetism, then being magnetically biased means being attracted towards or repelled from the first transferred field location 424, depending on the orientation of its North-South field, and the orientation of the transferred magnetic field.

Switch 400 further includes at least one cooperating fiber 440, having an end 442 in the capsule. In addition, switch 400 further includes a second cooperating fiber 450, having an end 452 in the capsule. Including second cooperating fiber 450 is highly preferred, but not necessary for practicing the invention.

Light may be exchanged between steerable fiber 430 and either one of cooperating fibers 440, 450. If steerable fiber 430 is the feeding fiber, i.e. the fiber that brings the light in switch 400, then switch 400 is a 1×2 switch. If cooperating fibers 440, 450 are the feeding fibers, then switch 400 is a 2×1 switch. Not including second cooperating fiber 450 would simply render device 400 an ON/OFF switch between fibers 430, 440.

Referring now also to FIG. 4B, and FIG. 4C, the operation of switch 400 is described.

In FIG. 4A, FIG. 4B, switch 418 is open, and the first magnetic field is not generated. Accordingly, armature 435 is not biased, and end 432 of steerable fiber 430 is at a rest position.

In FIG. 4C, switch 418 is closed, and the first magnetic field is generated. Accordingly, armature 435 is biased, and end 432 of steerable fiber 430 is moved from the rest position to a first position, where end 432 is aligned with end 442. There it can exchange light substantially efficiently with end 442 of first cooperating fiber 440.

In the drawings, it the biased armature 435 is shown contacting pole pieces 420, although that is not necessary for practicing the invention. Alternate arrangements can be made by different relative positions of stops 457, 467 that control the travel of end 432.

Since switch 400 includes second cooperating fiber 450, another arrangement is advantageously made. When end 432 of steerable fiber 430 is in the rest position of no alignment with fiber 440, it can exchange light substantially efficiently with end 452 of second cooperating fiber 450.

The advantage in this arrangement is that a single action of turning switch 418 ON or OFF can connect fiber 430 with either fiber 440 or fiber 450.

Another feature of the invention is that ends 442, 452 are not parallel to each other, contrary to what prior art teaches. In fact, they define a nonzero angle θ between them. More particularly, end 442 of first cooperating fiber 440 is at a first exchanging direction, when exchanging light with steerable fiber 430, and end 452 of second cooperating fiber 450 is at a second exchanging direction when exchanging light with steerable fiber 430. The first exchanging direction is at a nonzero angle θ from the second exchanging direction.

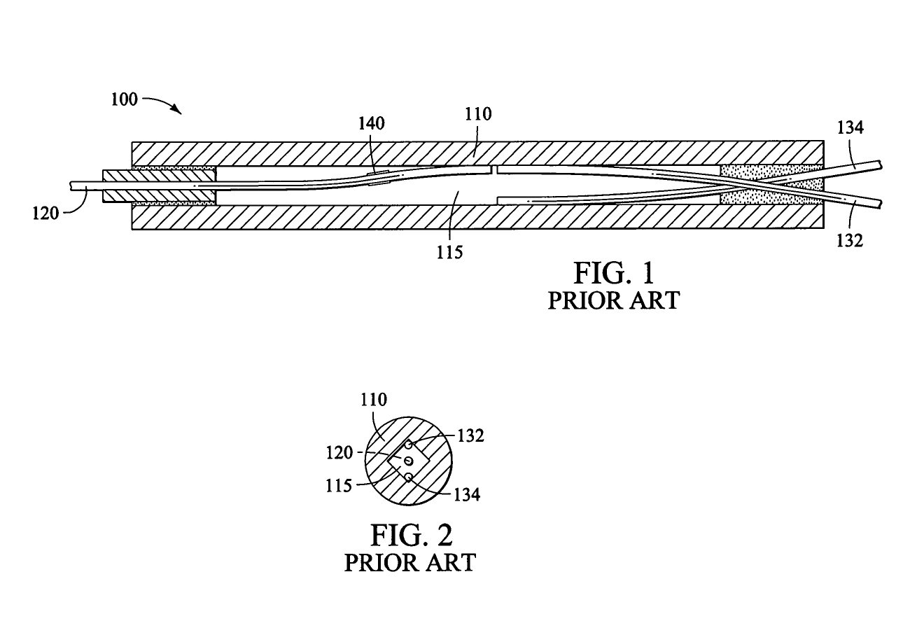

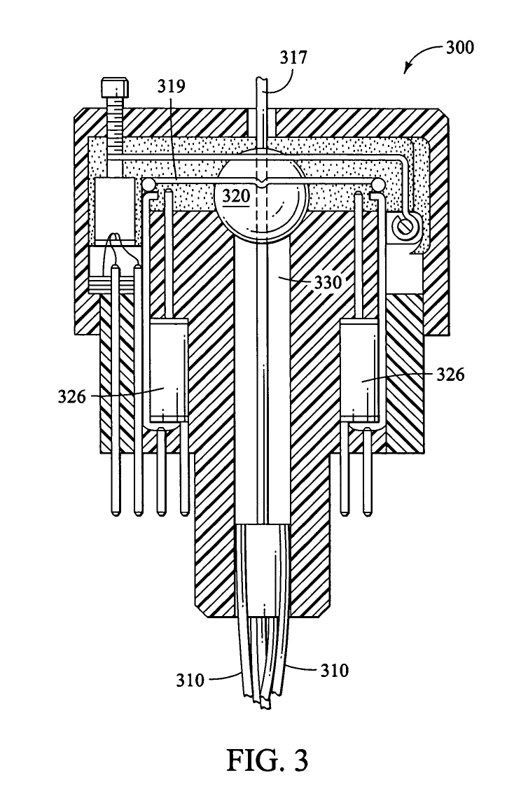

This feature permits better coupling by bending fibers 440, 450 less than that of the prior art, e.g. as seen in fibers 132, 134 of FIG. 1. It also permits exchanging light between 440, 450 and fiber 430 with less loss.

One more feature of the invention is that end 432 of steerable fiber 430 may be separately optionally prebiased with respect to the rest position. This is what enables switching coupling between two fibers with a single action.

In the case of switch 400, steerable fiber 430 is mounted such that end 432 is bent when at the first position. This way, steerable fiber 430 is prebiased by an internal fiber tensile force, which tends to keep the fiber straight. That force therefore resists bending, and tends to return steerable fiber 430 to the rest position. From the rest position, steerable fiber 430 may couple light with second cooperating fiber 450.

The invention thus takes advantage of one of the properties of optical fibers made from quartz. Such fibers have no “memory” of being bent, and always return to their shape. This way the switch does not lose efficiency after some time.

In other words, steerable fiber 430 is always bent, but less in the rest position (coupling with fiber 450) than in the first position (coupling with fiber 440). This is represented by steerable fiber 430 being shown mounted at an angle to a wall of bottom half 404 of the capsule.

In the case of switch 400, a stop 457 may present a groove for end 432 to be pushed in, by the internal fiber tensile force. End 452 of second cooperating fiber 450 may also be in the same groove, to better secure alignment. Stop 457 is advantageously mounted in bottom half 404 of the capsule.

Equally, when switch 418 is closed (as in FIG. 4C), another stop 467 may provide a meeting place for fiber ends 432, 442. Stop 467 is not shown in FIG. 4A, so as not to obscure salient features.

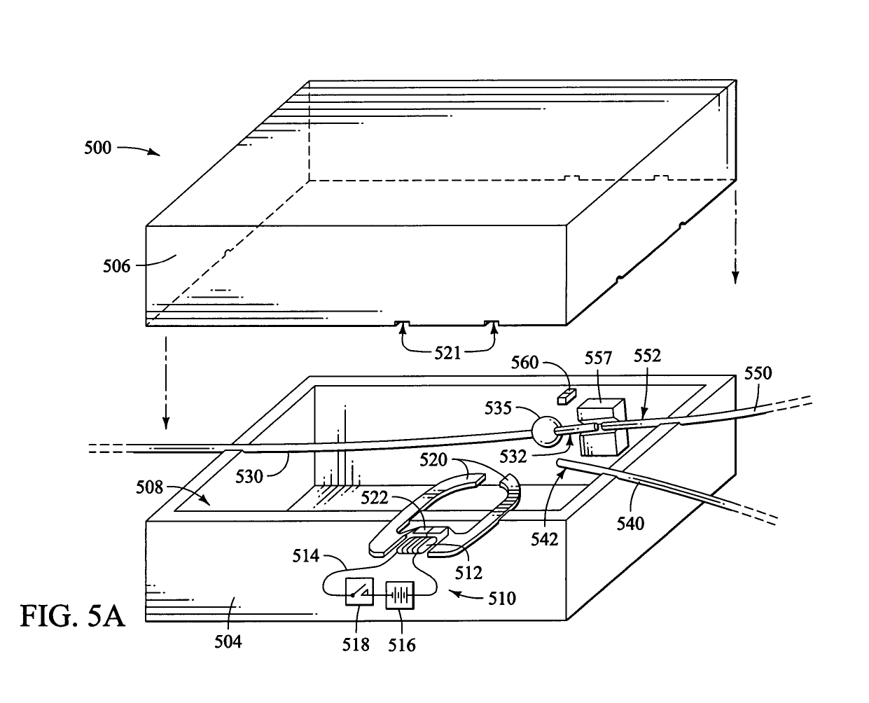

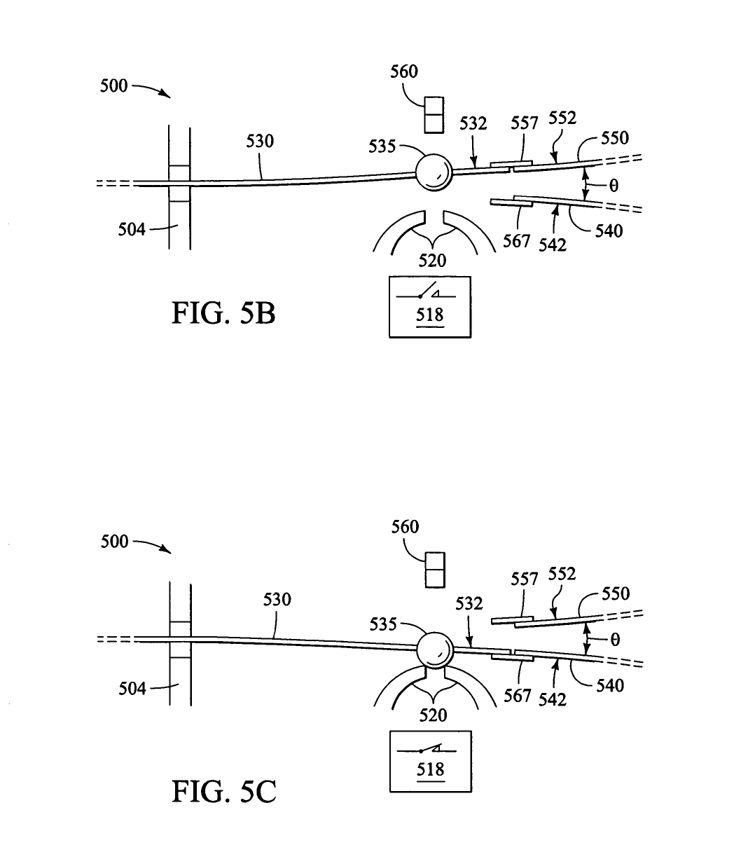

Referring now to FIG. 5A, a fiber-to-fiber switch 500 is shown, made according to another embodiment of the invention. It will be recognized that switch 500 includes many elements similar to those of switch 400, whose detailed description will therefore not be repeated in detail.

Switch 500 includes a capsule made from a bottom half 504 and a top half 506. They are intended to be closed together, thus defining an interior 508 of the capsule.

Switch 500 includes a first electromagnet 510 similar to electromagnet 410. First electromagnet 510 may be implemented inside or outside the capsule, similarly to electromagnet 410. First electromagnet 510 is controlled by a switch 518, similar to switch 418.

Switch 500 moreover includes a first pair of pole pieces 520, similar to first pair of pole pieces 420. As per the above, first pair of pole pieces 520 may go through a wall of the capsule.

Switch 500 also includes a first fixed magnet 522, which is made from a permanent magnet. Magnet 522 is called fixed because of its close cooperating relationship with pole pieces 520. Indeed, first fixed magnet 522 generates the first magnetic field in cooperation with first electromagnet 510. In other words, the fields cooperate. The field of first fixed magnet 522 is transferred by first pair of pole pieces 520 to a location inside the capsule, along with the field from the coil, when generated.

Switch 500 additionally includes a steerable fiber 530, having an end 532 in the capsule. Steerable fiber 530 is similar to steerable fiber 430.

Switch 500 further includes an armature 535, similar to armature 435, and attached to steerable fiber 530 near end 532.

Switch 500 moreover includes at least one cooperating fiber 540, having an end 542 in the capsule, and a second cooperating fiber 550, having an end 552 in the capsule.

Referring now also to FIG. 5B, and FIG. 5C, the operation of switch 500 is described.

In FIG. 5A, FIG. 5B, switch 518 is open, and the first magnetic field is not generated. Accordingly, armature 535 is not biased from the pole pieces 520, and end 532 of steerable fiber 530 is at a rest position.

A feature of switch 500 is that end 532 of steerable fiber 530 is separately prebiased with respect to the rest position. A permanent prebiassing magnet 560 generates a separate prebiasing field, to prebias armature 535. This makes for secure coupling, so that end 532 is aligned with end 552 of second cooperating fiber 550. There end 532 can exchange light substantially efficiently with end 552.

Magnet 560 is mounted in the capsule in any suitable way. Its strength is ideally enough to maintain steerable fiber 530 at the rest position, where there is coupling. This way, no electric current is needed to maintain a magnetic field, and better savings are realized.

Alternately, magnet 560 is mounted outside the interior 508 of the capsule. Pole pieces may or may not be provided to transfer its field to a location close to armature 535.

In FIG. 5C, switch 518 is closed, and the first magnetic field is generated, overcoming the prebiasing field of permanent prebiassing magnet 560. Accordingly, armature 535 is biased, and end 532 of steerable fiber 530 is moved to a first position. There end 532 is aligned with end 542 of first cooperating fiber 540, and can exchange light substantially efficiently with it.

Permanent prebiassing magnet 560 makes it so that a single action of turning switch 518 ON or OFF can connect fiber 530 with either fiber 540 or fiber 550. This way, steerable fiber 530 need not be bent by its mode of mounting, and may be mounted such that it is perpendicular to a side wall of bottom half 504 of the capsule.

For both positions, appropriate stops 557, 567 with grooves may provide meeting places for fiber end 532 to meet with fiber ends 542, 552.

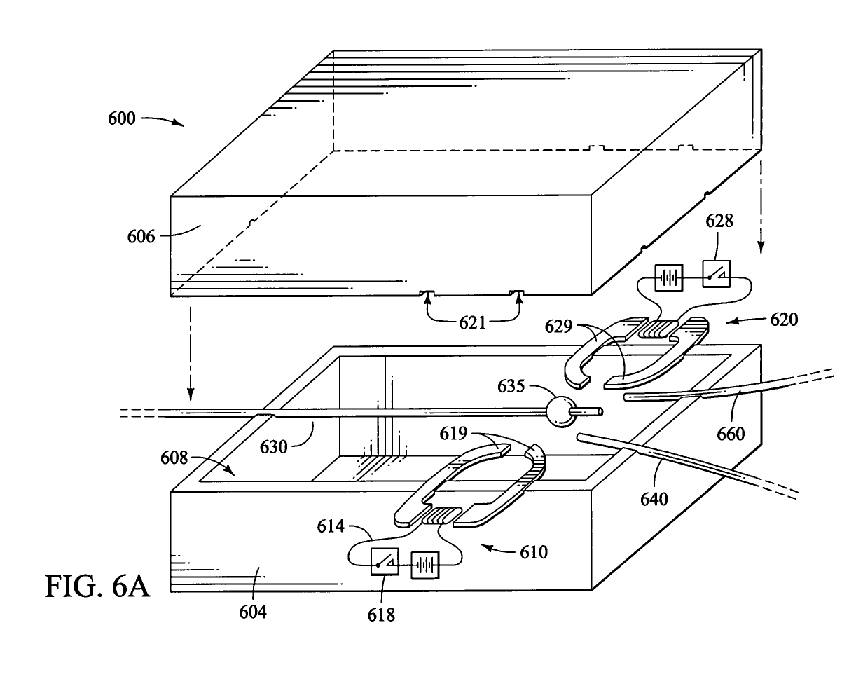

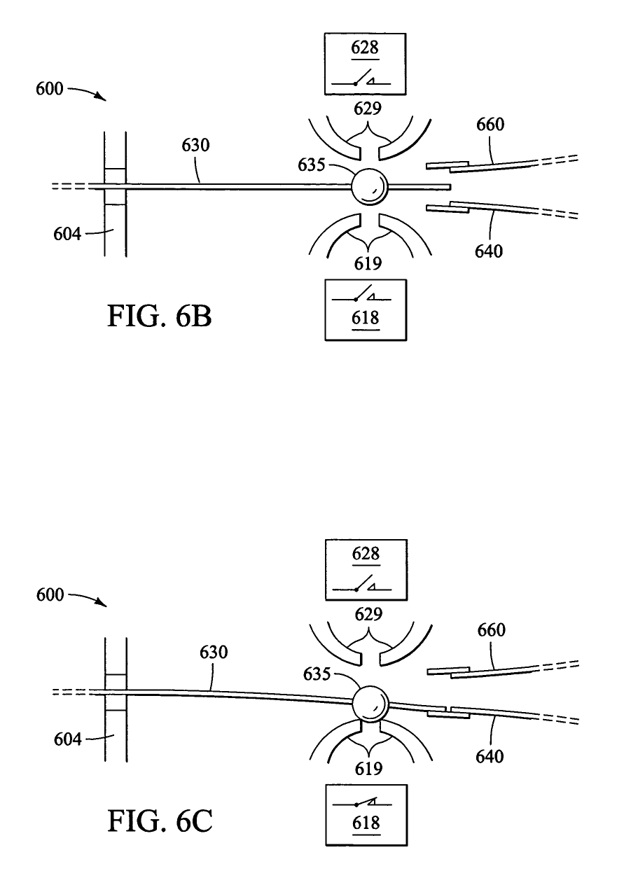

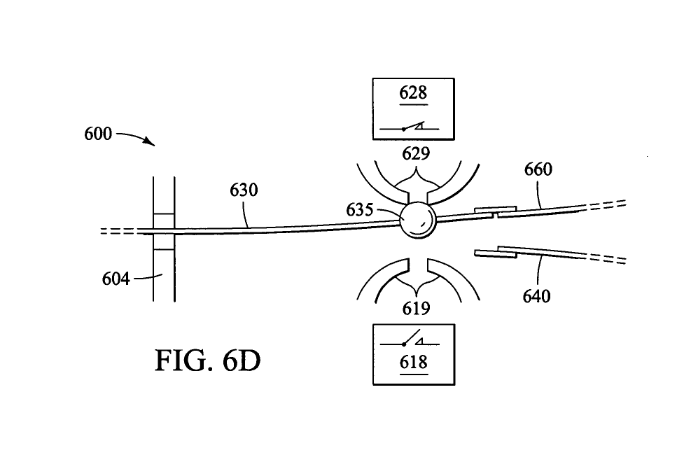

Referring now to FIG. 6A, a fiber-to-fiber switch 600 is shown made according to a third embodiment of the invention. It will be recognized that switch 600 includes many elements similar to those of switch 400, whose detailed description will therefore not be repeated.

Switch 600 includes a capsule made from a bottom half 604 and a top half 606. Top half 606 normally closes down on bottom half 604, thus defining an interior 608 of the capsule.

Switch 600 also includes a first electromagnet 610 for selectively generating a first magnetic field. First electromagnet 610 is controlled by a switch 618.

First electromagnet 610 is outside the capsule, although that is not necessary. First electromagnet 610 may equivalently be implemented to be within the capsule.

A first pair of pole pieces 619 transfer the first generated magnetic field from first electromagnet 610 to a first transferred field location inside the capsule. Pole pieces 619 are at least in part inside the capsule. In fact, they may go through a wall of the capsule.

Switch 600 moreover includes a second electromagnet 620, for selectively generating a second magnetic field. Second electromagnet 620 is controlled by a switch 628.

Second electromagnet 620 is outside the capsule, although that is not necessary. Second electromagnet 620 may equivalently be implemented to be within the capsule.

A second pair of pole pieces 629 transfer the second generated magnetic field from second electromagnet 620 to a second transferred field location inside the capsule. Pole pieces 629 are at least in part inside the capsule. In fact, they may go through a wall of the capsule. Pole pieces 629 are similar to pole pieces 619.

Switch 600 additionally includes a steerable fiber 630, similar to steerable fiber 430. An armature 635, similar to armature 435, is attached to steerable fiber 630.

Switch 600 further includes at least a first cooperating fiber 640 and a second cooperating fiber 660. Light may be exchanged between steerable fiber 630 and either one of cooperating fibers 640, 660.

A feature of switch 600 is that the end of steerable fiber 630 is not prebiased. It has a rest position between cooperating fibers 640, 660. Biasing is needed for steerable fiber 630 to become aligned with either one of cooperating fibers 640, 660.

When at the rest position, a tip of the end of steerable fiber 630 does not contact the capsule. In fact, armature 635 is cantilevered on steerable fiber 630 without contacting the capsule. This is especially possible from the little appreciated property of fused silica fibers that they never lose their shape, even in the face of persistent bending.

Referring now also to FIG. 6B, FIG. 6C, and FIG. 6D, the operation of switch 600 is described.

In FIG. 6A, FIG. 6B, switches 618, 628 are open. Neither the first nor the second magnetic field are generated. Accordingly, armature 635 is not biased, and the end of steerable fiber 630 is at the rest position.

In FIG. 6C, switch 618 is closed, and switch 628 is open. Accordingly, the first magnetic field is generated, but not the second. This biases armature 635, and the end of steerable fiber 630 is moved to a first position of alignment with fiber 640, where they can exchange light.

In FIG. 6D, switch 618 is open, and switch 628 is closed. Accordingly, the second magnetic field is generated, but not the first. This biases armature 635, and the end of steerable fiber 630 is moved to a second position of alignment with fiber 660, where they can exchange light.

As before, in both cases suitable stops confine the travel of the free end of steerable fiber 630, so that coupling is achieved. These stops are not shown in FIG. 6A, so as not to obscure salient features.

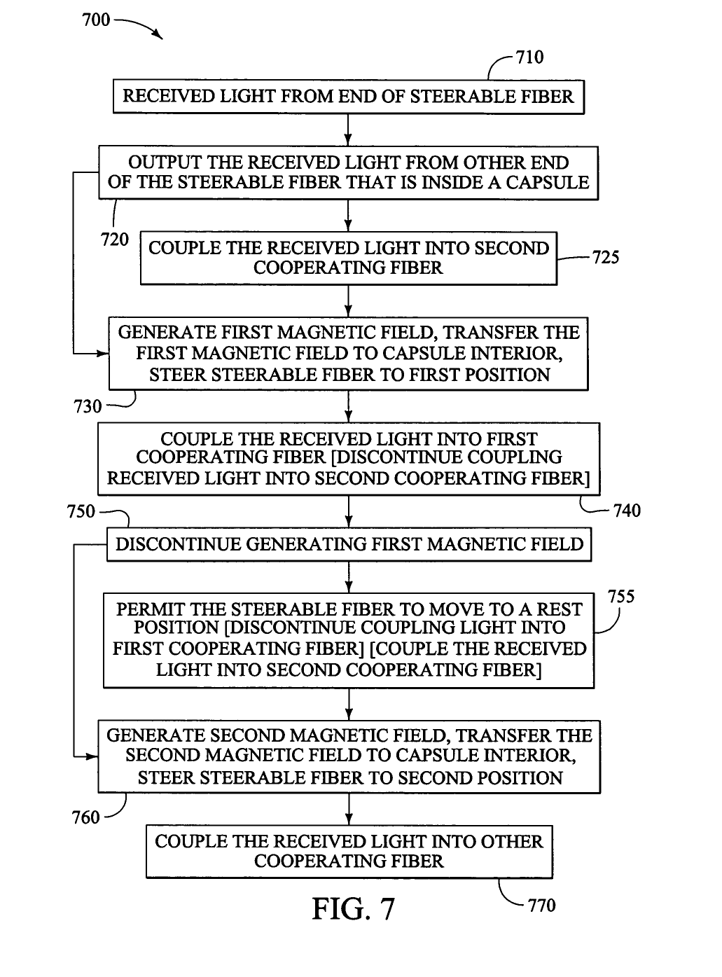

Referring now to FIG. 7, a flowchart 700 is used to illustrate a method according to an embodiment of the invention. Elements of the method of flowchart 700 may also be practiced by devices 400, 500 and 600 described above.

According to a box 710, light is received from an end of a steerable fiber. This would be the remote end from the switch, the end not shown in FIG.S 4A, 5A, 6A. Such light may be received on a continuous basis, and be either always on, or be switching ON and OFF to transmit digital signals.

According to a next box 720, the received light is output from the other end of the steerable fiber, in other words the end that is inside a capsule.

According to an optional next box 725, the received light is coupled into a second cooperating fiber, upon exiting from the steerable fiber. That is in the case, for example, of where in device 400 fiber 450 is indeed provided.

According to a next box 730, a first magnetic field is generated, and transferred to the capsule interior. Transferring is advantageously performed by pole pieces. The steerable fiber is steered to a first position, responsive to the transferred magnetic field. It is enough if only the end of the steerable fiber is thus moved.

According to a next box 740, the received light is coupled into a first cooperating fiber. This is a result of moving the steerable fiber to the first position. If, at box 725 the received light was being coupled into a second cooperating fiber, that is discontinued.

According to a next box 750, generation of the first magnetic field is discontinued. This could be for switching a switch for another signal. Accordingly, biasing from the first magnetic field is also discontinued.

According to an optional next box 755, the steerable fiber is permitted to move to a rest position, as a result of discontinuing biasing from the first magnetic field. This will discontinue coupling light into first cooperating fiber, since the steerable fiber moves away from the first position. When at the rest position, the fiber may couple the received light into the second cooperating fiber.

According to a next box 760, a second magnetic field is generated, and transferred to the capsule interior. Transferring is advantageously performed by pole pieces. The steerable fiber is thus steered to a second position, responsive to the transferred magnetic field. It is enough if only the end of the steerable fiber is thus moved.

According to a next box 770, the received light is coupled into another cooperating fiber, as a result of being in the second position.

In addition, the method described above is for a 1×2 switch. The process equivalently reversed for 2×1 switch.

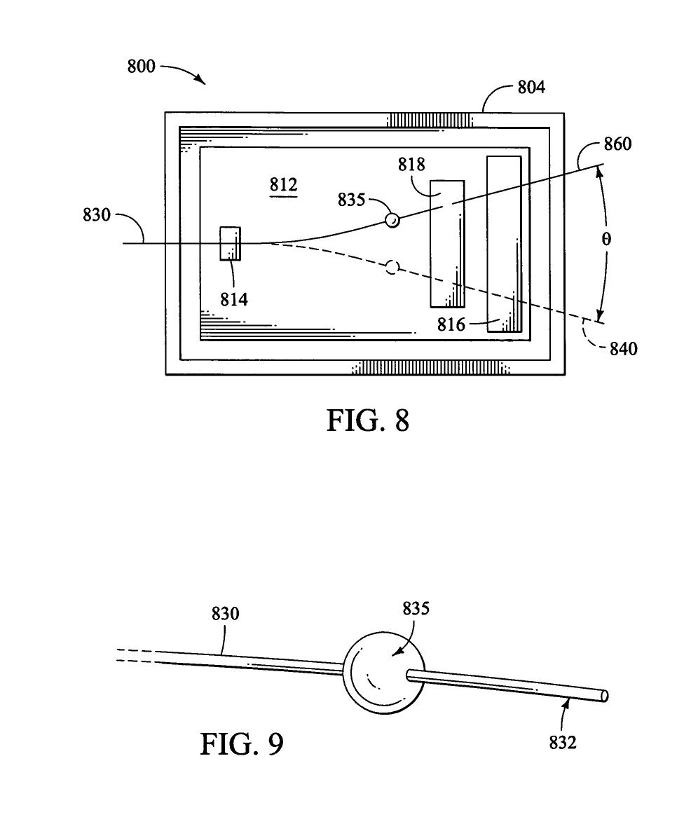

Referring now to FIG. 8, parts of a switch 800 are shown. These parts may also be used in devices 400, 500, 600.

Switch 800 may be established in a bottom half 804 of a capsule. A top half (not shown) may be added later.

An optical bench 812 may be placed in bottom half 804. Pedestals 814, 816, 818 are provided on bench 812.

A steerable fiber 830 is provided in a pedestal 814. Its output end terminates inside the capsule, and has an armature 835. Armature 835 may be biased by magnetic field transferred into the capsule by pole pieces (not shown).

Two cooperating fibers 840, 860 are mounted on pedestal 816, at a nonzero angle θ. This angle is actually very small, about a few degrees. It is shown large, to better emphasize the aspect.

Fibers 830, 840, 860 are thus mounted on the pedestals, and designed for end-to end coupling. The end of fiber 830 is brought very close to that of fiber 860 (solid line). In the other switching position, the end of fiber 830 is brought very close to that of fiber 840 (dashed line).

A bench 818 supports structure needed to ensure secure the coupling. This structure may include properly positioned grooves, etc.

Bench 812 may be made from fused silica. This results in the same temperature expansion coefficient as the fibers. As temperature changes, so does the distance between the pedestals, but not the distance between the fibers. Accordingly, the fiber ends may be brought very close, for better coupling.

Referring now to FIG. 9, a detail of steering fiber 830, made according to the invention.

Longitudinal optical fiber 830 is suitable for waveguiding light. Fiber 830 has an output end 832. It may be made from fused silica, as is known for fibers.

Fiber 830 includes a substantially spherically shaped armature 835, attached near output end 832. Armature 835 is made from a material responsive to a magnetic field, for selectively steering output end 832. Preferably, armature 835 is spherically shaped.

Armature 835 need not be a magnet. It may be made by forming a drop of liquid glue around the fiber, suspending metal particles in the drop, and then curing the glue. Alternately, armature 835 is a standalone magnet. For purposes of this document standalone magnet means either a permanent magnet, or a magnet made from material that has been subsequently magnetized.

A switch made according to the invention has shown very promising results. In a test of longevity, a 1-by-2 switch passed 500 million switching cycles without a problem and was still running smoothly.

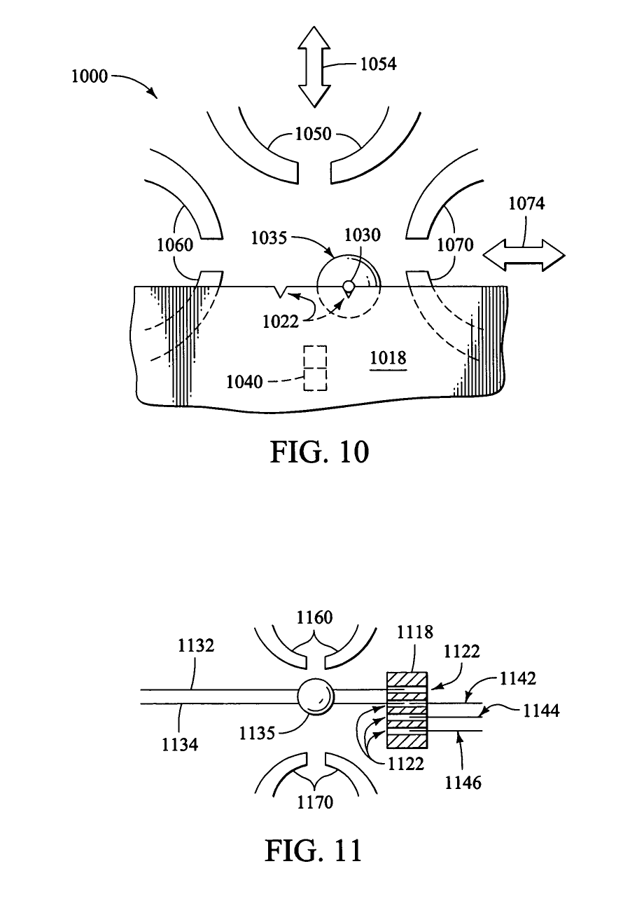

Referring now to FIG. 10, an alternate design is shown according to the invention. A switch 1000 includes a pedestal 1018, similar to pedestal 818. Pedestal 818 has two grooves 1022, which are horizontally disposed.

A fiber 1030 is to be placed into grooves 1022, to make contact with other cooperating fibers (not shown). Fiber 1030 has an armature 1035, made similarly to armature 835, and is moved by magnetic fields.

A permanent prebiasing magnet 1040 exerts a field on armature 1035. This way, permanent prebiasing magnet 1040 maintains steerable fiber 1030 in whichever one of grooves 1022 it was last placed, without applying any current.

A first pair of pole pieces 1050 are designed to transfer a selectively generated vertical magnetic field, so as to overcome the field of permanent prebiasing magnet 1040. This way, they can lift steerable fiber 1030 out of groove 1022 by its armature 1035, along a vertical direction 1054. When the vertical magnetic field is no longer generated, permanent prebiasing magnet 1040 prevails, and moves armature 1035 downwards, along vertical direction 1054. An appropriate stop (not shown) may be used to prevent overtravel of steerable fiber 1030 and its armature 1035.

A second pair of pole pieces 1060 and a third pair of pole pieces 1070 are designed to transfer selectively generated horizontal magnetic fields. This way, they can shift steerable fiber 1030 by its armature 1035 along a horizontal direction 1074. They would do this preferably when steerable fiber 1030 has been lifted out of the one of grooves 1022 that it was placed in, for being aligned with the other. Lifting would take place along vertical direction 1054, as described above. Again, appropriate stops (not shown) may be used to prevent overtravel of steerable fiber 1030 and its armature 1035.

Switch 1000 may be optimized in a number of ways. For example, one of pairs of pole pieces 1060, 1070 may be substituted by a permanent magnet. For another example, three grooves 1022 may be used instead of two.

In other improvements, a single armature may be used for two fibers.

Referring to FIG. 11, a steerable fiber 1132 and an auxiliary steerable fiber 1134 share a common armature 1135. They are to be coupled in various combinations with at least one of cooperating fibers 1142, 1144, 1146. Coupling is over a pedestal 1118, having groves 1122.

Pairs of pole pieces 1160 and 1170 are designed to transfer selectively generated horizontal magnetic fields. This way, they can shift the pair of steerable fiber 1132 and auxiliary steerable fiber 1134 by their shared armature 1135, and guide it to the right pair of groves 1122.

A person skilled in the art will be able to practice the present invention in view of the description present in this document, which is to be taken as a whole. Numerous details have been set forth in order to provide a more thorough understanding of the invention. In other instances, well-known features have not been described in detail in order not to obscure unnecessarily the invention.

While the invention has been disclosed in its preferred form, the specific embodiments as disclosed and illustrated herein are not to be considered in a limiting sense. Indeed, it should be readily apparent to those skilled in the art in view of the present description that the invention may be modified in numerous ways. The inventor regards the subject matter of the invention to include all combinations and subcombinations of the various elements, features, functions and/or properties disclosed herein. For example, a switch may be made with combinations of elements from switches 400, 500, 600. Plus, switch 600 can have a second fixed magnet to generate the second magnetic field in cooperation with the second electromagnet, and so on.

The following claims define certain combinations and subcombinations, which are regarded as novel and non-obvious. Additional claims for other combinations and subcombinations of features, functions, elements and/or properties may be presented in this or a related document.

The invention claimed is:

1. An optical fiber switch device, comprising:
a capsule;
a first electromagnet for selectively generating a first magnetic field, the first electromagnet having a coil that is outside the capsule;
a first pair of pole pieces being at least in part inside the capsule for transferring the first generated magnetic field to a first transferred field location inside the capsule;
a steerable fiber having an end in the capsule;
an armature attached to the steerable fiber near the end, the armature being responsive to the transferred first magnetic field by being magnetically biased with respect to the first transferred field location; and
a first cooperating fiber having an end in the capsule,
and in which when the armature is biased with respect to the first transferred field location, the end of the steerable fiber is moved to a first position where it can exchange light substantially efficiently with the end of the first cooperating fiber.

2. The device of claim 1, further comprising:
a first fixed magnet to generate the first magnetic field in cooperation with the first electromagnet.

3. Cancelled.

4. The device of claim 1, in which
the first pair of pole pieces goes though a wall of the capsule.

5. The device of claim 4, in which
the capsule is made from two halves, and
one of the two halves has recesses to accommodate the first pair of pole pieces.

6. The device of claim 1, in which
when the end of the steerable fiber is moved to the first position, it is moved there from a rest position, and
the end of the steerable fiber is separately prebiased with respect to the rest position.

7. The device of claim 6, in which
the steerable fiber is mounted such that its end is bent when at the first position, thereby being prebiased by an internal fiber tensile force which resists bending.

8. The device of claim 6, further comprising:
a permanent prebiassing magnet to generate a separate prebiasing field to prebias the armature.

9. The device of claim 6, further comprising:
a second cooperating fiber having an end in the capsule,
and in which when the end of the steerable fiber is in the rest position, it can exchange light substantially efficiently with the end of the second cooperating fiber.

10. The device of claim 9, in which
the end of the first cooperating fiber is at a first exchanging direction when exchanging light with the steerable fiber,
the end of the second cooperating fiber is at a second exchanging direction when exchanging light with the steerable fiber, and
the first exchanging direction is at a nonzero angle from the second exchanging direction.

11. The device of claim 1, further comprising:
an auxiliary steerable fiber having an end attached to the armature.

12. The device of claim 1, further comprising:
a second electromagnet for generating a second magnetic field;
a second pair of pole pieces being at least in part inside the capsule for transferring the generated magnetic field to a second transferred field location inside the capsule, and
in which the armature is responsive to the transferred second magnetic field by being magnetically biased with respect to the second transferred field location.

13. The device of claim 12, in which
the second electromagnet has a coil that is outside the capsule, and
the second pair of pole pieces goes though a wall of the capsule.

14. The device of claim 13, in which
the capsule is made from two halves, and
one of the two halves has recesses to accommodate the second pair of pole pieces.

15. The device of claim 12, further comprising:
a second fixed magnet to generate the second magnetic field in cooperation with the second electromagnet.

16. The device of claim 12, in which
when neither the first nor the second magnetic field are generated, the output end is at a rest position,
biasing from the rest position with respect to the first transferred field location is performed along a first direction, and
biasing from the rest position with respect to the second transferred field location is performed along a second direction that is at a nonzero angle to the first direction.

17. The device of claim 12, further comprising:
a second cooperating fiber having an end in the capsule,
and in which when the armature is biased with respect to the second transferred field location, the end of the steerable fiber is moved to a second position where it can exchange light substantially efficiently with the end of the second cooperating fiber.

18. The device of claim 17, in which
the end of the first cooperating fiber is at a first exchanging direction when exchanging light with the steerable fiber,
the end of the second cooperating fiber is at a second exchanging direction when exchanging light with the steerable fiber, and
the first exchanging direction is at a nonzero angle from the second exchanging direction.

19. A steerable optical fiber, comprising:
a longitudinal optical fiber suitable for waveguiding light, and having an output end; and
a substantially spherically shaped armature attached to the fiber near the output end, the armature made from a material responsive to a magnetic field for selectively steering the output end.

20. The fiber of claim 19, in which
the armature is spherically shaped.

21. The fiber of claim 19, in which the armature is made by
forming a drop of liquid glue around the fiber,
suspending metal particles in the drop, and
then curing the glue.

22. The fiber of claim 19, in which
the armature is a standalone magnet.

23. A method comprising:
receiving light from an end of a steerable fiber;
outputting the received light from an output end of the steerable fiber that is inside a capsule;
generating a first magnetic field from a coil located outside of the capsule;
transferring the generated first magnetic field to a first transferred field location inside the capsule, to bias with respect to the first transferred field location an armature attached to the output end, thereby steering the steerable fiber to a first position; and
then coupling substantially more of the received light into a first cooperating fiber than prior to generating the first magnetic field.

24. The method of claim 23, further comprising:
discontinuing generation of the first magnetic field;
then generating a second magnetic field;
transferring the generated second magnetic field to a second transferred field location inside the capsule, to bias the armature with respect to the second transferred field location, thereby steering the steerable fiber to a second position; and
then coupling substantially more of the received light into a second cooperating fiber than prior to generating the second magnetic field.

25. The fiber of claim 19, in which the fiber and armature are arranged in a capsule such that, when the armature is biased by a magnetic field inside the capsule, the output end of the steerable fiber is moved to a first position in the capsule where it can exchange light substantially efficiently with a first cooperating fiber.

26. The fiber of claim 25, in which
when the output end of the steerable fiber is moved to the first position, it is moved there from a rest position, and
the output end of the steerable fiber is separately prebiased with respect to the rest position.

27. The fiber of claim 25, in which
the steerable fiber is mounted in the capsule such that the fiber is bent when at the first position, thereby being prebiased by an internal fiber tensile force which resists bending.

28. The fiber of claim 25, in which:
the capsule contains a second cooperating fiber having an end in the capsule; and
in which when the output end of the steerable fiber is in the rest position, it can exchange light substantially efficiently with the end of the second cooperating fiber.

29. The fiber of claim 26 in which:
when moving from the rest position to the first position, the steerable fiber moves in a first plane; and
the steerable fiber can be caused to move in a second plane transverse the first plane.

30. The fiber of claim 19, further comprising:
an auxiliary steerable fiber having an end attached to the armature.

31. The method of claim 24, in which,
steering the steerable fiber to a second position comprises moving the steerable fiber in a first plane, the method further comprising:
prior to generating the second magnetic field, generating another magnetic field to bias the armature and to cause the steerable fiber to move in a second plane, the second plane different than the first plane.

32. The method of claim 31 in which the second plane is transverse the first plane.

33. The method of claim 32 in which the second plane is substantially orthogonal to the first plane.
